(19) United States
(12) Patent Application Publication
(10) Pub. No.: US 2007/0158499 A1
(43) Pub. Date: Jul. 12, 2007

(54) Aircraft air disinfection system

(76) Inventor: David Whittingham, 7 ASHLANDS SALE CHESHIRE M33 5PB (GB)

Correspondence Address: KLARQUIST SPARKMAN, LLP, 121 SW SALMON STREET, SUITE 1600, PORTLAND, OR, 97204, US

(21) Appl. No.: 10/559,630

(22) PCT Filed: Jun. 4, 2004
(86) PCT No.: PCT/GB04/02395

§ 371 Date: Sep. 11, 2006

(30) Foreign Application Priority Data
Jun. 6, 2003 (GB) 0312978.0

(51) Int. Cl. B64D 11/00

(52) U.S. Cl. 244/118.5

(57) ABSTRACT

An aircraft air conditioning system for conditioning of the cabin and/or cockpit air comprises an air re-circulation circuit (13, 14, 15, 16) and a UVC radiation unit (12) positioned so as to irradiate air in the re-circulation circuit (13, 14, 15, 16) with ultra violet light. The air conditioning system comprises a re-circulation fan (14) having the inlet thereof connected to a mechanical filter (33), and the output connected to a mixer unit (13) adapted to mix re-circulated air supplied to the mixer unit (13) by the fan (14), and a UVC radiation unit (12) positioned so as to irradiate the re-circulated air with ultra violet light at a wavelength of nm.

This invention relates to an aircraft air disinfection system, and to disinfection units for use with aircraft air conditioning systems.

Modern commercial passenger jet aircraft are provided with air conditioning systems which are arranged to re-circulate about 40-50% of air from the passenger cabin and to mix the re-circulated air with about 60-50% of fresh air which has been suitably pressurised. Studies have shown that the re-circulated air can contain micro-biological bacteria and viruses (Indoor Built Environ, 1999; 8: 58-66).

The invention aims to reduce or eliminate most organisms and viruses in the re-circulated air.

Present air conditioning systems, such as those in an Airbus A319/320/321 and most modern passenger jet aircraft, employ one or more re-circulation fans to feed re-circulated air to a mixer unit in which the re-circulated air is mixed with fresh air. The re-circulation fan inlets are generally provided with a cylindrical filter cartridge for mechanically filtering particles from the re-circulated air.

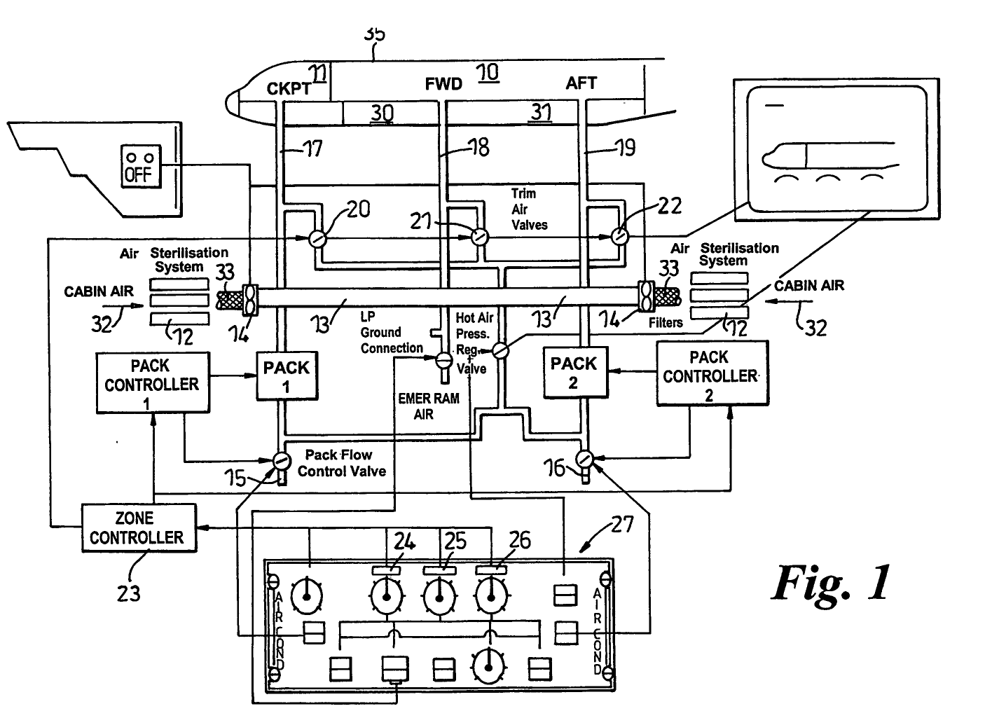

As stated in Indoor Built Environ, 1999; 8:59,
‘Commercial flights travel at an altitude of 10,000-15,000 m, where the temperature is around −60° C., and the air is almost dry. At this altitude, the air is so thin that a person would become confused and lethargic in less than a minute. Even at an altitude of only 2,500 m, the unconstrained volume of air is 30% greater than at sea-level, and the atmospheric pressure correspondingly reduced. Therefore, to create an acceptable atmosphere, air taken in at altitude has to be compressed and heated to the proper pressure and temperature and then conditioned in an environmental control unit before it is introduced into the cabin.
In commercial aircraft, the source of ventilation air is the engine compressor bleed air which has a temperature and pressure much higher than that required for space heating or cooling requirements. This air is passed through heat exchangers, where it is cooled to the required comfort temperature. A flow-controlled valve, controlled manually by the crew or automatically, regulates the quantity of air through the heat exchangers. By controlling the quantity, this valve controls the temperature of the air through the heat exchangers. A zone re-heating system in the cabin provides further control of the cabin temperature. The flow-controlled valve also allows crews to adjust airflow rate when the aircraft is carrying less than a full load of passengers. FIG. 1 shows a schematic drawing of a typical air distribution system in a commercial aircraft [Canadair: Canadair Regional Jet Maintenance Training Manual, 1992]. As shown in this schematic, each aircraft has two identical air conditioning systems, which are designed to work independently or in parallel.
The air entering the main duct is distributed in the passenger cabin through the full-length grilled outlets situated on the sidewalls below the storage bins and from overhead diffusers in the passenger compartment entry way. Exhaust air is removed through the floor level grilles alongside the wall via the left and right tunnels, to the outflow valves. The cabin pressure is controlled by regulating the amount of the exhaust air: the planes are designed and constructed to maintain an air pressure that is at least equivalent to the air pressure at 2,500 m above sea level (around 560 mm Hg).
The mechanical ventilation system in an aircraft built before the 1980s delivers up to 5.7 m³ of outdoor air per person per minute corresponding to a nominal air exchange rate of 23-27 per hour (depending on the volume of the passenger cabin). However, the mechanical ventilation system of a more modern aircraft only delivers about half of that amount, although this is still more than the air exchange in, say, commercial buildings. The total amount of air delivered in the more modern craft is unchanged, and the amount is made up from re-circulated air from the passenger cabin. Fulton (Fulton HB Jr: A pilot's guide to gain air quality and fire safety. NY State J Med 1985;85:384-388) has documented the possible causes of aircraft mechanical system deficiency in providing sufficient air, distribution and filtration.’

The experience of one of the inventors in the food processing industry is that micro-organisms can be destroyed by irradiating them with ultra violet light at 253.7 nm emitted by low-pressure mercury discharge lamps. We have considered whether it would be possible to provide UVC radiation of the cabin air re-circulated within an aircraft.

According to one aspect of the invention an aircraft air conditioning system for conditioning of the cabin and/or cockpit air, comprises an air re-circulation circuit and a UVC radiation unit positioned so as to irradiate air in the re-circulation circuit with ultra violet light.

UVC radiation is radiation in the short-wave band of the UV spectrum. The full UV spectrum extends from 100 nm to 400 nm, and the UVC spectrum is from 100 to 280 nm. A strong germicidal effect is known to be provided by the radiation in the short-wave UVC band. However, radiation of wavelengths below 240 nm is known to form ozone (O₃) which is toxic.

The peak of germicidal action against wavelength is known to occur at 265 nm. The primary radiation generated by low-pressure mercury discharge lamps is a spectral line at 253.7 nm which is conveniently close to the ideal peak wavelength.

Preferably the air conditioning system comprises a re-circulation fan having the inlet thereof connected to a mechanical filter, and the output connected to a mixer unit adapted to mix re-circulated air supplied to the mixer unit by the fan, and a UVC radiation unit positioned so as to irradiate the re-circulated air with ultra violet light at a wavelength of 253.7 nm.

The pipework associated with the re-circulation fan, mechanical filter and mixer unit is, however, of necessarily limited dimensions. We prefer to locate the irradiation unit in a plenum chamber which feeds the re-circulated air to the mechanical filters.

The plenum chamber is preferably a chamber which receives re-circulated air from various air outlets from the cabin and/or cockpit.

In general the air re-circulation fan, mechanical filters and mixer unit are located in the fuselage below the passenger cabin and substantially in line with the roots of the aircraft wings.

We prefer to locate the UVC emitters in a plenum chamber to which the mechanical filters are exposed for ingesting re-circulated air from the plenum chamber.

In an Airbus A319/320/321 there is such a plenum chamber located between a fixed bulkhead to the rear of said filters and a removable transverse bulkhead, and we prefer to mount the UVC irradiation unit within that plenum chamber.

A particular advantage of locating the UVC irradiation unit in this location is that a suitable power supply is available nearby. The unit is readily accessible for maintenance through the maintenance openings provided for the existing air conditioning unit.

An aircraft air disinfection system in accordance with the invention and suitable for use in an Airbus A319/320/321 will now be described, by way of example only, with reference to the accompanying drawings in which:

FIG. 1 is a schematic circuit diagram of an air conditioning system incorporating the disinfection unit;

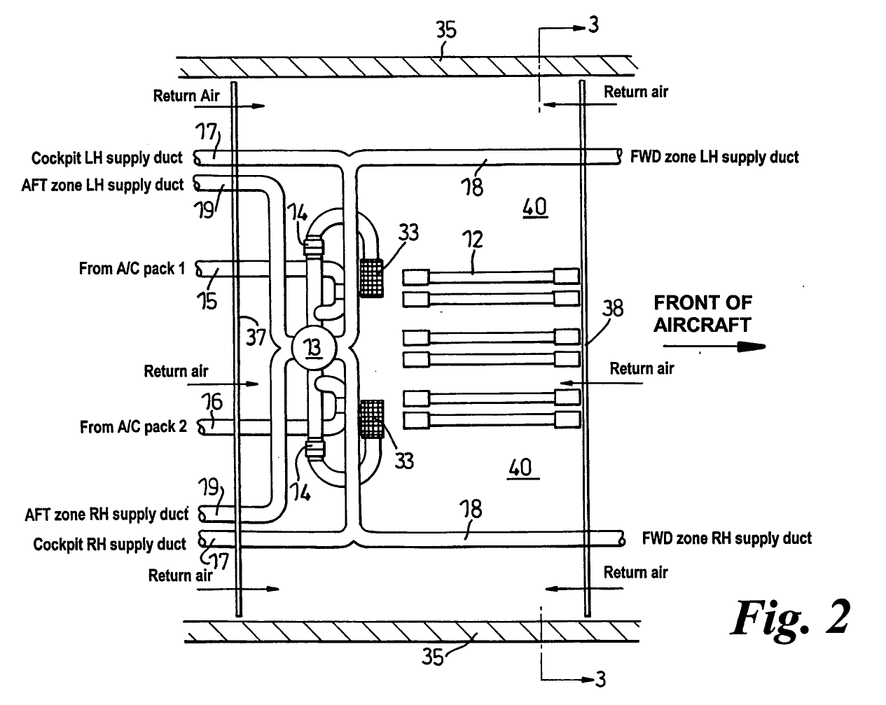

FIG. 2 is a plan view of the mechanical filters and re-circulation fans and associated pipework housing in the fuselage beneath the cabin floor and between the wings;

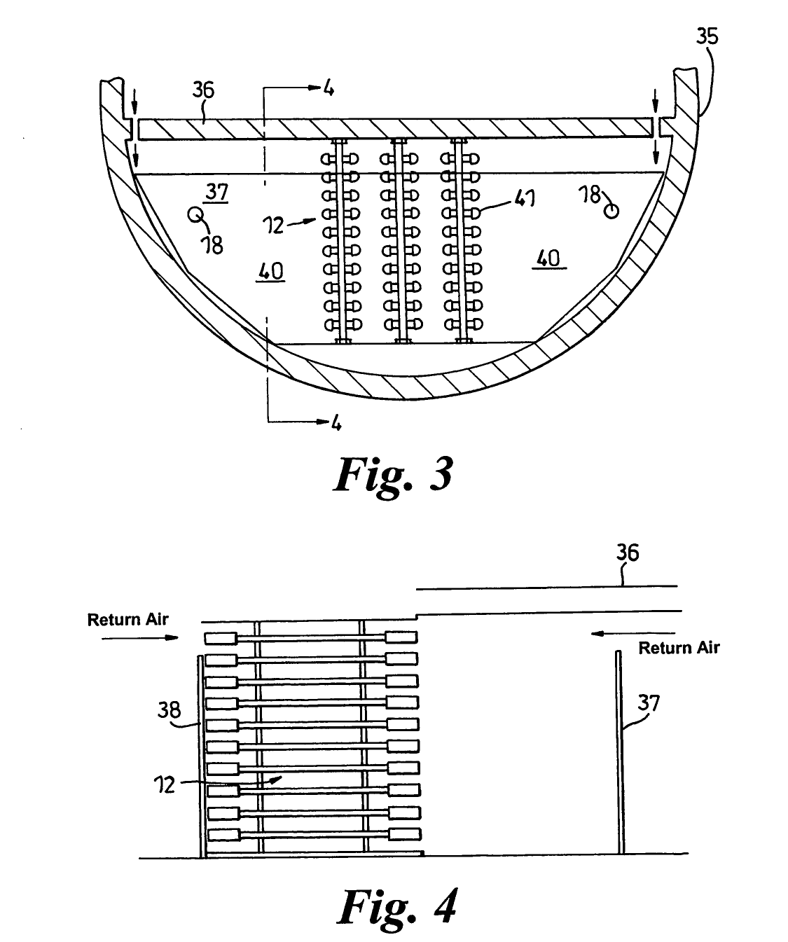

FIG. 3 is a transverse cross-section of the lower part of the fuselage on the line 3-3 of FIG. 2;

FIG. 4 is a section on the line 4-4 of FIG. 3 of the UVC irradiation unit located in the plenum between a fixed bulkhead and a removable bulkhead, but omitting the re-circulation fans, mixer unit and associated pipework.

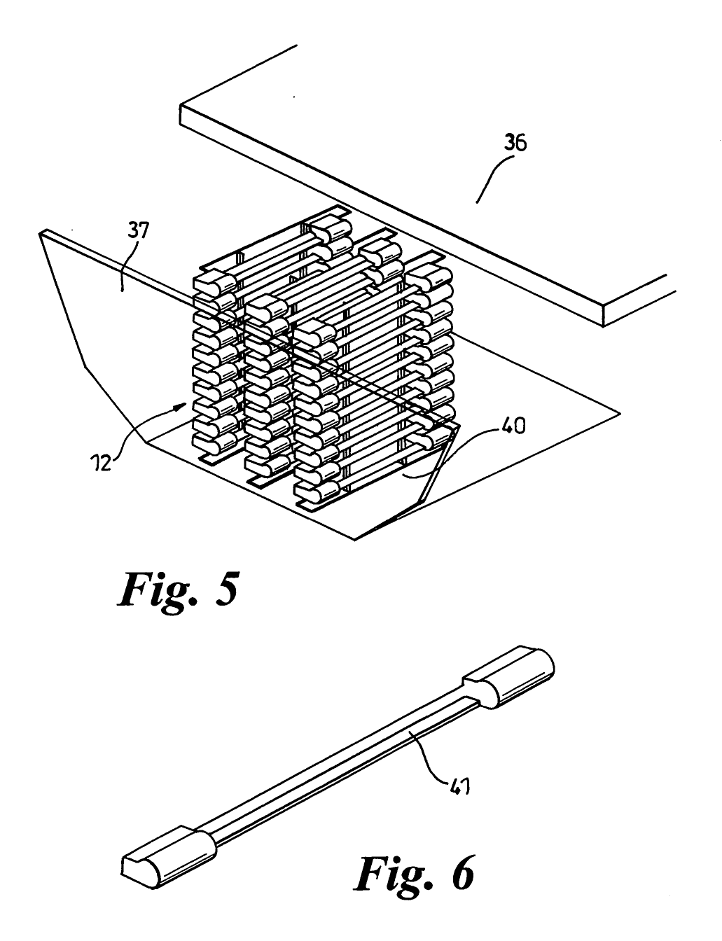

FIG. 5 is a schematic, partially cut-away, isometric view of the UVC irradiation unit; and

FIG. 6 is an isometric view of one of the UVC elements of the unit of FIG. 5.

FIG. 1 shows a substantially conventional air conditioning system for the cabin 10 and cockpit 11 of a passenger aircraft, but which has been modified in accordance with the present invention to incorporate a disinfection unit in the form of a UVC irradiation unit 12.

The system comprises a mixing unit 13 for mixing re-circulated air from the cabin and cockpit provided by re-circulation fans 14 with fresh air supplied on lines 15, 16 from bleed air supplies in respective jet engines. PACK 1 and PACK 2 are servo-valves controlled by respective controllers, Pack Controller 1 and Pack Controller 2, and control, in well-known manner, the amount of fresh air supplied to the mixing unit 13 for supply by the mixing unit to a cockpit supply line 17, a forward passenger cabin supply line 18, and a rear passenger cabin supply line 19.

Trim air valves 20, 21, 22 enable heated fresh air to be supplied to lines 17, 18, 19 respectively, in known manner, to provide some control of the temperature of the air being supplied on lines 17, 18 and 19, under the control of a zone controller 23 in response to manual settings set on controls 24, 25, 26 of control panel 27.

FIG. 1 does not show the return air circuits from the cockpit 11 and cabin 10 but these are conventional, and well known. Cabin air is extracted through vents in the cabin floor which lead into the cargo holds, air from the forward part of the cabin 10 passing into the forward cargo compartment 30, and air from the aft part of the cabin 10 passing into the rear cargo compartment 31.

The portion of the air extracted from the passenger cabin that is not to be re-circulated is fed in well-known manner to a flap type outflow valve, conveniently located at the rear end of the fuselage. The remaining portion of the extracted air indicated by arrow 32 is fed to the inlets of fans 14 by way of the irradiation unit 12.

Although two irradiation units 12 are shown in FIG. 1 it is possible to use a single unit 12 which deals with the supplies to both fans 14.

As shown in FIG. 1 the inlets of fans 14 are provided with respective cylindrical mechanical filters 33 in the form of replaceable cartridges, for filtering out particulate matter, such as dust, from the re-circulated air.

FIG. 2 shows the location of the mixer unit 13 and filter 33, and associated piping, in the fuselage 35 of an Airbus A319/320/321. As shown, the lower part of the fuselage, beneath cabin floor 36 is provided with a fixed bulkhead 37, at the front end of the aft cargo compartment, and a removable bulkhead 38 at the rear end of the forward cargo hold. This is in the part of the fuselage located between the wings. A convenient plenum chamber 40 is defined between the bulkhead 37 and the bulkhead 38, said plenum chamber being supplied with the air for re-circulation. The filters 33 are located in and therefore exposed to the plenum.

In accordance with the invention we have installed in plenum chamber 40, the UVC irradiation unit 12 which, as shown in FIGS. 3 to 5 comprises banks of UVC tube assemblies 41, one of which is shown in FIG. 6. The UVC tube assemblies 41 are low pressure mercury lamps which emit ultra violet light at 253.7 nm, and a sufficient number are provided to kill substantially all micro-organisms and viruses which may be present in the air returned from the cabin.

Suitable UVC tube assemblies are available from BÄRO Applied Technology Limited of 36 Wood Lane, Partington, Manchester M31 4ND.

A suitable monitoring and control system, not shown, is provided via an electrical panel connected to the aircraft electrical system. Suitable electrical supplies are available in the aircraft in the vicinity of the plenum chamber 40.

By arranging for all of the re-circulated air to pass through the interior of casing 42, it is arranged that all of the re-circulated air is subject to UVC radiation emitted by tube assemblies 41.

Since the plenum chamber defined between the bulkhead 37 and bulkhead 38 is generally of significant length (135 cm in a Airbus 320) there will usually be a plenum chamber of adequate dimensions to accommodate a UVC irradiation unit in accordance with the invention, without any significant structural changes being necessary.

1. An aircraft air conditioning system for conditioning cabin and/or cockpit air in an aircraft, comprising an air re-circulation circuit and a UVC radiation unit positioned so as to irradiate air in the re-circulation circuit with ultra violet light.

2. An air conditioning system as claimed in claim 1 comprising at least one re-circulation fan having an inlet thereof connected to a mechanical filter and an output connected to a mixer unit adapted to mix re-circulated air supplied to the mixer unit by the fan, the UVC radiation unit being positioned so as to irradiate the re-circulated air with ultra violet light at a wavelength of 253.7 nm.

3. An air conditioning system as claimed in claim 2 in which the irradiation unit is located in a plenum chamber which feeds the re-circulated air to the mechanical filter.

4. An air conditioning system as claimed in claim 3 in which the plenum chamber is a chamber which receives re-circulated air from multiple air outlets from the cabin and/or the cockpit of the aircraft.

5. An air conditioning system as claimed in claim 4 in which the re-circulation fan, mechanical filter and mixer unit are located in the fuselage of the aircraft below the passenger cabin and substantially in line with the roots of the aircraft wings.

6. An air conditioning system as claimed in claim 4 which the UVC radiation unit comprises a plurality of UVC emitters located in the plenum chamber to which the mechanical filter is exposed for ingesting re-circulated air from the plenum chamber.

7. An aircraft fitted with an air conditioning system as claimed in claim 1.

8. A kit of parts for providing an aircraft with an air conditioning system as claimed in claim 1.

9. An air conditioning system as claimed in claim 2 in which the at least one re-circulation fan comprises at least first and second re-circulation fans, each fan having an inlet fluidly connected to a respective mechanical filter and an outlet fluidly connected to the mixer unit.

10. An air conditioning system as claimed in claim 5 in which the UVC radiation unit comprises a plurality of UVC emitters located in the plenum chamber to which the mechanical filter is exposed for ingesting re-circulated air from the plenum chamber.

11. An air conditioning system for conditioning cabin and/or cockpit air in an aircraft, comprising:
means for re-circulating air in the aircraft; and
means for irradiating re-circulated air with ultra-violet light.

12. An air conditioning system as claimed in claim 11 further comprising means for mixing irradiated re-circulated air with fresh air.

13. An air conditioning system as claimed in claim 12 further comprising means for distributing irradiated re-circulated air mixed with fresh air to the cabin and/or the cockpit.

14. An air conditioning system as claimed in claim 11 in which the means for irradiating re-circulated air with ultra-violet light comprises a plurality of UVC emitters located in a plenum that is configured to receive re-circulated air to be irradiated from the cabin and/or cockpit.

15. An air conditioning system as claimed in claim 14 in which the plenum is located in the aircraft fuselage below the passenger cabin and substantially in line with the roots of the aircraft wings.

16. An aircraft fitted with an air conditioning system as claimed in claim 11.

17. A method for conditioning air in an aircraft, the method comprising:
irradiating re-circulated air with ultra-violet light;
mixing irradiated re-circulated air with fresh air; and
distributing the irradiated re-circulated air mixed with fresh air to the cabin and/or the cockpit of the aircraft.

18. The method as claimed in claim 17 in which the re-circulated air is irradiated with ultra-violet light at a wavelength of about 253.7 nm.

19. The method as claimed in claim 17 further comprising filtering irradiated re-circulated air prior to mixing the irradiated re-circulated air with fresh air.

20. The method as claimed in claim 17 wherein substantially all of the re-circulated air in the aircraft is irradiated with ultra-violet light.
